(19) United States
(12) Patent Application Publication
(10) Pub. No.: US 2011/0304569 A1
(43) Pub. Date: Dec. 15, 2011

(54) Panel Member Having Oscillating Element

(75) Inventors: Yoshihiro Kai, Kyoto (JP); Yoshiko Suetomi, Kyoto (JP); Yuji Watazu, Kyoto (JP)

(73) Assignee: NISSHA PRINTING CO., LTD., Kyoto-shi, Kyoto (JP)

(21) Appl. No.: 13/141,210

(22) PCT Filed: Dec. 7, 2009
(86) PCT No.: PCT/JP2009/006671

§ 371 Date: Aug. 17, 2011

(30) Foreign Application Priority Data
Dec. 26, 2008 (JP) 2008-333924

(51) Int. Cl. G06F 3/041

(52) U.S. Cl. 345/173

(57) ABSTRACT

By changing the method of attaching an oscillating element to a panel member, it is made possible to render the construction simple, yet, to provide oscillation to the panel member with uniform and equal drive force. In a panel member 4 having a touch type information inputting function, a reduced-rigidity portion 4a whose rigidity is reduced is provided in at least a portion of a peripheral edge 4A thereof. An oscillating element 21, 22 is provided a center side thereof including the reduced-rigidity portion 4a. The panel member relating to the present invention is effectively used in an electronic instrument such as a mobile phone and can be utilized for improvement of performance, enhanced compactness and lightweight of the electronic instrument equipped with a panel member.

### TECHNICAL FIELD

The present invention relates to a panel member having a touch-type information inputting function for use in an electronic instrument, mainly such as a mobile phone, a smart phone, a PDA, a car navigation apparatus, a digital camera, a digital video camera, a game machine, etc.

### BACKGROUND ART

Touch panel type input devices are sorted mainly into resistive touch panel input devices and capacitance type touch panel input devices. Of these, the resistive touch panel input device comprises a movable plate and a support substrate stacked one above the other with a slight insulating spacing therebetween so as to provide separation between conductive layers formed on the mutually opposed faces thereof. In operation, when the movable plate is pressed, contact is formed between the conductive layers at this pressed position. This contact is electrically detected and pressed position data representing this pressed position is outputted to a processor such as a personal computer.

With this type of touch panel input devices, since a movable plate and a support substrate are stacked with a slight electrically insulating spacing therebetween, the operational stroke for a pressing operation of the movable plate is very small as small as from 0.01 to 0.5, so the operator cannot know whether an input operation has been effected by a pressing of the movable plate.

Then, as disclosed in e.g. Patent Document 1 and Patent Document 2, there has been developed a force-feedback type touch panel device configured to allow the operator to feel the operation from his/her finger through vibration of the movable plate and/or the support substrate.

In Patent Document 1, a rectangular-shaped panel member is provided as the movable plate, and a piezoelectric substrate is bonded along one longitudinal side of the back face of this panel member, thus constituting a force-feedback type touch panel device.

In Patent Document 2, a rectangular-shaped panel member is provided as the movable plate, and a cutout portion is formed along a side of the support substrate. Then, within this portion, a piezoelectric substrate is accommodated and fixedly attached and this support substrate and the panel member are bonded together, thus constituting a force-feedback type touch panel device.

With these force-feedback touch panel devices, a piezoelectric substrate having a pair of driving electrodes fixedly attached to the mutually opposed faces thereof is fixedly attached to the movable plate or the support substrate, either directly or via the driving electrode. In operation, upon detection of a pressing on the input operational face of the touch panel, a driving voltage is applied to the pair of driving electrodes, which causes extension/contraction of the piezoelectric substrate, which extension/contraction in turn causes vibration of the movable plate or the support substrate.

Further, also in a panel-like speaker disclosed in Patent Document 3, an acoustic oscillation plate acting also as a panel is oscillated by an oscillating driver, thereby to output a sound.

### PRIOR ART DOCUMENTS

### Patent Documents

Patent Document 1: Japanese Patent No. 3798287
Patent Document 2: Japanese Patent No. 3871991
Patent Document 3: Japanese Patent No. 3512087

### SUMMARY OF THE INVENTION

### Object to be Achieved by Invention

However, in the case of the arrangements disclosed in Patent Document 1 and Patent Document 2 wherein a piezoelectric substrate 22 is directly bonded along one side of a peripheral edge of a movable plate 4, as illustrated in FIG. 13, the movable plate 4 will be oscillated and flexed in the bonding direction of the piezoelectric substrate 22 (the y-coordinate axis direction in FIG. 13), but there is provided no force for flexing the movable plate 4 in the non-bonding direction of the piezoelectric substrate 22 (the x-coordinate axis direction in FIG. 13). That is, for the movable plate 4 as a whole, its oscillation direction is limited, so that oscillation of the movable plate 4 may not be transmitted sufficiently to the operator, depending on the position at which the operator presses the movable plate 4.

Further, in the case of the arrangement disclosed in Patent Document 3, the oscillating driver is disposed at a corner portion of the rectangular-shaped movable plate. Therefore, the oscillation direction is not limited to one direction; however, if it is desired to increase the vibration, it is necessary to increase the number of oscillating drivers.

In view of the above, the object of the present invention is to make it possible to render the construction simple, yet, to provide the panel member with oscillation by uniform and equal drive force, through changing the method of attaching the oscillating element to the panel member.

### Solution for Achieving the Object

According to the first characterizing feature of a panel member relating to the present invention, a panel member having the touch type information inputting function, comprises:

a reduced-rigidity portion whose rigidity is reduced is provided in at least a portion of a peripheral edge of said panel member, and

an oscillating element disposed at the center side of said panel member including the reduced-rigidity portion.

With the above-described arrangement, there occurs no limiting in directions of oscillation of the panel member in either one direction, the lateral (x-coordinate axis) direction or the vertical (y-coordinate axis) direction, and oscillation of the panel member is allowed at this rigidity-reduced portion of the panel member, thus oscillation being rendered uniform in the lateral (x-coordinate axis) direction and the vertical (y-coordinate axis) direction. As a result, substantially uniform oscillation is obtained over the entire panel member. Further, with this achievement of substantially uniform oscillation over the entire panel member, it becomes also possible to generate various modes of oscillation in the panel member through change of the positions of the oscillating elements to be laid out and/or control of the amount of the oscillation.

According to the second characterizing feature of the panel member relating to the present invention, said reduced-rigidity portion is a recessed groove portion.

With the above-described arrangement, the reduced-rigidity portion can be readily provided in the panel member. And, the construction is made simple and through selection of the depth, the width or the like of the recessed groove portion, the rigidity of the panel member can be readily controlled.

Furthermore, if the oscillating element is attached within the recessed groove portion of the panel member, this results in reduction in the thickness of the panel member by the amount corresponding to the depth of the recessed groove portion, so that it becomes possible to reduce the thickness of the panel member as a whole including the oscillating element. Consequently, the electronic instrument having the panel member can be formed even more compact and light weight.

According to the third characterizing feature of the panel member relating to the present invention, said panel member as a whole has a rectangular shape, and said recessed groove portion is provided at least along one side of said panel member.

With the above-described arrangement, the recessed groove portion is formed along the lateral (x-coordinate axis) direction or the vertical (y-coordinate axis) direction of the panel member, thus facilitating transmission of oscillation substantially across the surface of the panel member. Further, a panel member often has a near rectangular shape; hence, by increasing/decreasing e.g. the number, the width etc. of the recessed groove portion depending on the requirement from the panel member, adjustment of the amount of the oscillation and control of various modes of oscillation, etc. can be effected easily.

According to the fourth characterizing feature of the panel member relating to the present invention, said oscillating element includes a base portion and an elongate oscillating member supported cantilever-wise from said base portion.

With the above-described construction, it becomes possible to increase the oscillation of the panel member, in comparison with a normal oscillating element. As a result, it becomes possible to oscillate the entire panel member with fewer oscillating elements. Further, in cooperation with the reduced-rigidity portion provided in the panel member, it becomes also possible to generate various modes of oscillation according to the needs of the panel member.

### BRIEF DESCRIPTION OF THE DRAWINGS

FIG. 1 a perspective view of a mobile phone,

FIG. 2 a section of principal portions showing configuration of a panel member according to a first embodiment,

FIG. 3 an exploded section of principal portions showing configuration of the panel member according to the first embodiment,

FIG. 4 a plan view of a lower electrode film,

FIG. 5 a bottom view of an upper electrode film,

FIG. 6 a section of principal portions showing an attaching arrangement of the panel member according to the first embodiment,

FIG. 7 a perspective view of principal portions showing the attaching arrangement of the panel member and the oscillating element according to the first embodiment,

FIG. 8 a perspective view of principal portions showing the attaching arrangement of the panel member and the oscillating element according to the first embodiment,

FIG. 9 a view showing layout of the oscillating element relative to a panel member according to a further embodiment,

FIG. 10 a view showing layout of the oscillating element relative to a panel member according to a further embodiment,

FIG. 11 a view showing layout of the oscillating element relative to a panel member according to a further embodiment,

FIG. 12 a view showing layout of the oscillating element relative to a panel member according to a further embodiment, and

FIG. 13 a view showing layout of the oscillating element relative to a panel member according to the prior art.

### MODES OF EMBODYING THE INVENTION

Next, a first embodiment of the present invention will be described with reference to the accompanying drawings.

A panel member relating to the present invention is put for use in a mobile instrument, as a mobile phone, a smart phone, a PDA, a car navigation apparatus, a digital camera, a digital video camera, a game machine, etc. In this embodiment, a protective panel for use in a mobile phone will be described as an example of the panel member.

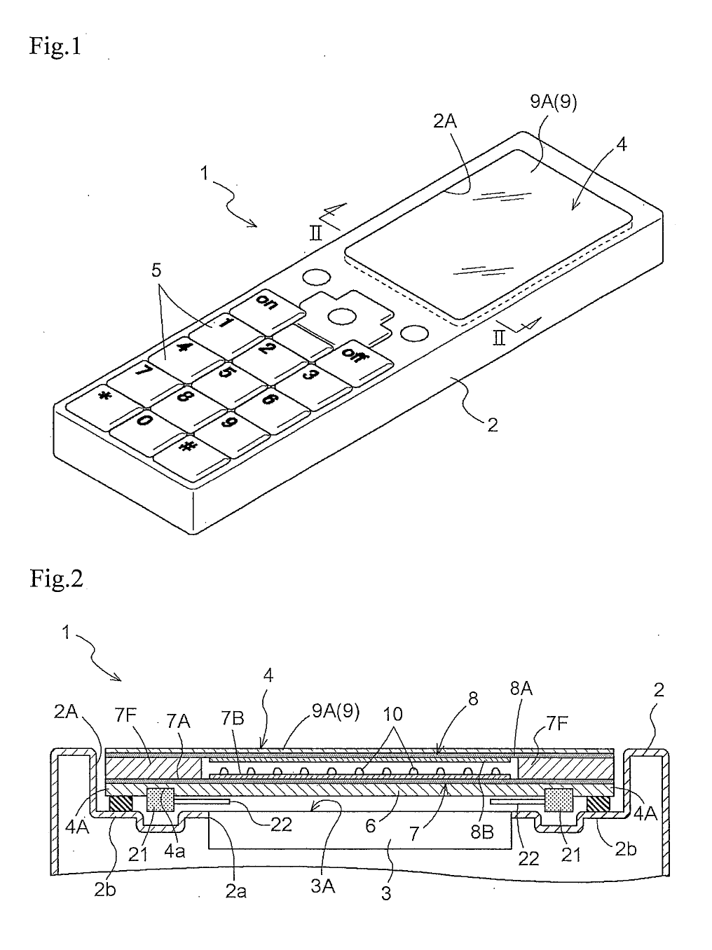

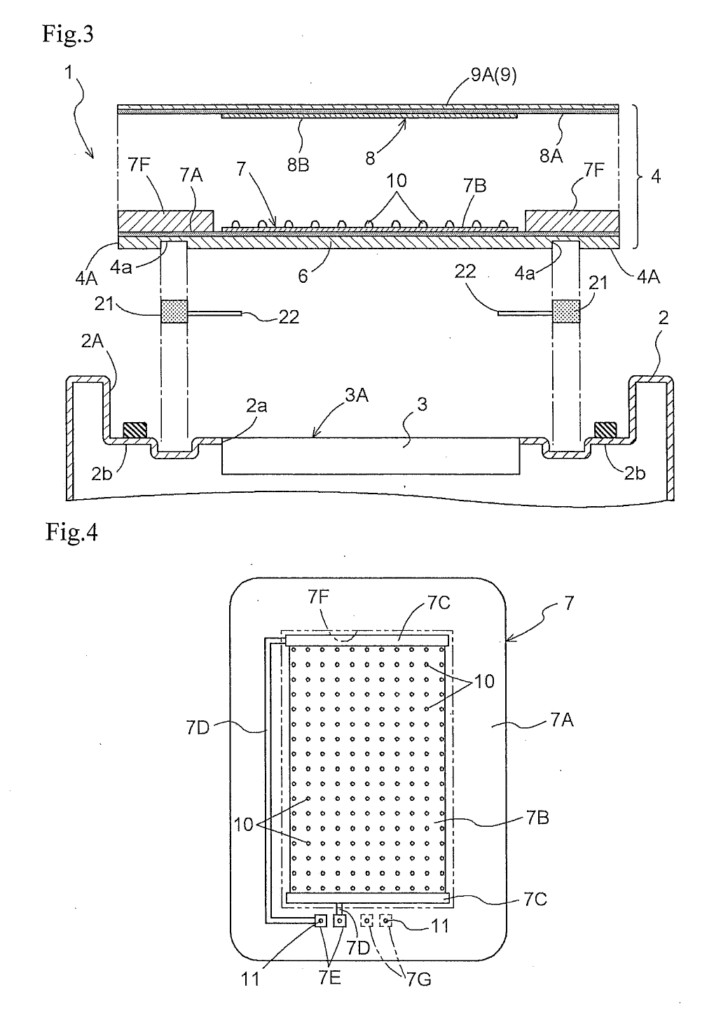

FIG. 1 is a perspective view showing a mobile phone 1. FIG. 2 is a section of principal portions along a line II-II in FIG. 1 showing a configuration of a panel member according to the first embodiment. FIG. 3 is an exploded section of the principal portions showing the configuration of the panel member according to the first embodiment.

### First Embodiment

As shown in FIGS. 1-3, the mobile phone 1 with a protective panel 4, an example of the panel member, includes, as being housed within a casing 2 formed of a synthetic resin and having a display window on the front face thereof, a display device 3 having a displaying section 3A such as of liquid crystal, organic EL, etc., the protective panel 4 for coating and protecting the surface of this display device 3 and a plurality of input keys 5, etc.

The display window 2A of the casing 2, as shown in FIG. 1 and FIG. 2, is formed as a recessed portion having a step for allowing fitting of the protective panel 4 therein. The bottom face of the display window 2A is opened to form an opening 2a for exposing the displaying section 3A of the display device 3 mounted within the casing 2 to the outside and a frame-like supporting portion 2b for supporting a back face peripheral edge 4A of the protective panel 4.

The shape and the size of the display window 2A can vary according to the shape and/or size of the protective panel 4. Further, the recessed depth of the display window 2A can vary according to e.g. the thickness of the protective panel 4. Moreover, the shape and the size of the opening 2a of the display window 2A can vary according to the shape and/or size of the displaying section 3A. In this embodiment, the display window 2A, the opening 2a, the displaying section 3A and the protective panel 4 all have a rectangular or near rectangular shape and the recessed depth of the display window 2A is set such that the surface of the casing 2 and the surface of the protective panel 4 are substantially level with each other.

The protective panel 4 can be chosen between one having the so-called touch inputting function configured such that X-Y coordinates as its operational position are detected based on a touching operation on the protective panel 4 and one not having such touch inputting function. And, the panel having the touch inputting function can be chosen from the resistive touch type, capacitance type, electromagnetic induction type, etc. In this embodiment, the resistive touch type panel having the touch inputting function will be described as an example.

As shown in FIG. 2 and FIG. 3, the protective panel 4 includes a support plate 6 formed with using a material having good transparency and rigidity such as resin, glass and a lower electrode film 7 bonded to the upper face of the support plate 6, an upper electrode film 8 disposed in opposition upwardly of the lower electrode film 7 via an air layer formed upwardly of the lower electrode film 7, a decorative sheet 9 affixed to the upper face of the upper electrode film 8. With these components, the protective panel 4 is configured to provide the function as the resistive touch panel A.

The resin used in the support plate 6 can be a resin having good transparency and rigidity, such as polycarbonate resin (PC), methacryl resin (PMMA), acrylonitrile-styrene copolymer resin (AS), acrylonitrile-butadiene-styrene copolymer resin (ABS), cellulose propionate resin (CP), polystyrene resin (PS), polyester resin, and polyethylene resin. Of these, it is preferred to use polycarbonate resin (PC) or methacryl resin (PMMA) having particularly good transparency. Further, the glass usable in the support plate 6 can be soda glass, borosilicate glass, tempered glass, etc.

Further, the thickness of the support plate 6 can be chosen from the range of 0.5 to 3.0 mm, and 1.0 mm is particularly preferred.

As shown in FIGS. 2-4, in the lower electrode film 7, on the upper face of a transparent insulating substrate 7A, there are formed a rectangular-shaped transparent conductive film 7B, a pair of parallel lower bus bars 7C disposed on opposed two sides of the transparent conductive film 7B, a pair of leader circuits 7D and a pair of connecting electrodes 7E disposed along the perimeter of the transparent conductive layer 7B and a frame-like bonding layer 7F.

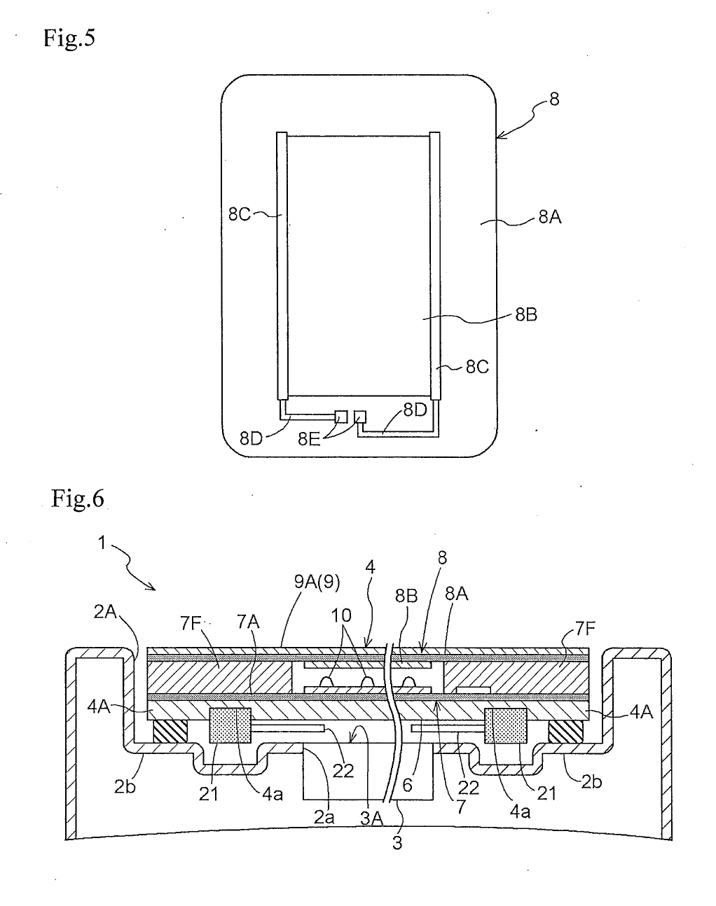

As shown in FIG. 2, FIG. 3 and FIG. 5, in the upper electrode film 8, on the lower face of a flexible transparent insulating substrate 8A having a property of being flexed in response to a pressing thereof with a finger or the like, there are formed a rectangular-shaped transparent conductive film 8B, a pair of parallel upper bus bars 8C disposed on opposed two sides of the transparent conductive film 8B, a pair of leader circuits 8D and a pair of connecting electrodes 8E disposed along the perimeter of the transparent conductive layer 8B.

As the transparent insulating substrate 7A of the lower electrode film 7 and the flexible transparent insulating substrate 8A of the upper electrode film 8, it is possible to employ an engineering plastic of polycarbonate, polyamide, polyether ketone, etc. or a transparent film of acryl, polyethylene terephthalate, polybutylene terephthalate, etc.

As the transparent conductive films 7B, 8B of the lower electrode film 7 and the upper electrode film 8, it is possible to employ a metal oxide film such as tin oxide, indium oxide, antimony oxide, zinc oxide, cadmium oxide, indium tin oxide (ITO), etc. or a composite film containing such metal oxide as a major component thereof, or a metal film of gold, silver, copper, tin, nickel, aluminum, palladium, etc. Further, the transparent electrode films 7B, 8B can be multiple layers including two or more layers.

The method of forming the transparent conductive films 7B, 8B can be vacuum deposition, sputtering, ion plating, CDV method, etc.

As shown in FIGS. 1 through 3, on the surface of either one of the transparent conductive films 7B, 8B, a plurality of small dot-like spacers 10 can be formed for preventing erroneous contact between these transparent conductive films 7B, 8B when these are placed in opposition to each other.

The spacers 10 can be formed of a transparent light-curing resin of epoxy acrylate type or urethane acrylate type or a transparent heat-curing resin of polyester type or epoxy type. Further, the method of forming the spacers 10 can be a printing method such as screen printing technique or a photo process, etc.

The lower bus bars 7C, the upper bus bars 8C, the leader circuits 7D, 8D and the connecting electrodes 7E, 8E can be formed with using paste having electrical conductivity such as of a metal, e.g. gold, silver, copper, nickel, or carbon. And, the method of forming these can be a printing method such as the screen printing, the offset printing, the gravure printing, flexographic printing, etc., or photo-resist technique or brush applying technique, etc.

In general, the lower bus bars 7C and the upper bus bars 8C are formed as closely as possible to the extreme ends of the transparent insulating substrate 7A or the flexible transparent insulating substrate 8A so as to secure, at the center portion of the transparent insulating substrate 7A or the flexible transparent insulating substrate 8A, as large as possible an area not having the lower bus bars 7C or upper bus bars 8C.

The size and the shape of the area not having the lower bus bars 7C or upper bus bars 8C, that is, the inputting area or the displaying area, can vary according to the size, shape of the inputting area or displaying area available in an electronic instrument equipped with a protective panel such as the mobile phone 1.

The decorative sheet 9 is comprised of a flexible transparent insulating substrate 9A, a hard coating layer formed on the upper face of the flexible transparent insulating substrate 9A and a picture layer and a bonding layer (neither shown) formed on the lower face of the flexible transparent insulating substrate 9A.

As the flexible transparent insulating substrate 9A of the decorative sheet 9, it is possible to employ an engineering plastic of polycarbonate, polyamide, polyether ketone, etc. or a transparent film of acryl, polyethylene terephthalate, polybutylene terephthalate, etc.

The thickness of the flexible transparent insulating substrate 9A can be chosen from the range of 50 to 200 μm, and the thickness ranging from 100 to 125 μm is particularly preferred.

The material used in the hard coating layer of the decorative sheet 9 can be an inorganic material such as siloxane resin or an organic material such as of the acryl epoxy type, urethane heat-curing type resin or acrylate type light-curing resin, etc. The appropriate thickness of the hard coating layer should range from 1 to 7 μm.

The method of forming the hard coating layer can be a coating technique such as roll coating technique, a spray coating technique or a standard printing technique such as screen printing, offset printing, gravure printing, flexographic printing, etc. The hard coating layer can be formed directly on the upper face of the flexible transparent insulating substrate 9A having the bottom face on which the picture layer and the bonding layer are formed directly. Or, the hard coating layer can be formed on a further flexible transparent insulating substrate other than the flexible transparent insulating substrate 9A having the bottom face on which the picture layer and the bonding layer are formed directly. Thereafter, these two flexible transparent insulating substrates can be affixed and bonded together.

Optionally, the decorative sheet 9 can be subject to an additional treatment such as an emboss work for forming convex and concave portions on the flexible transparent insulating substrate 9A and/or the hard coating layer or a non-glare treatment for prevention of light reflective scattering by e.g. mixing fine particles of silica, alumina or the like as the body pigment within the hard coating layer.

For forming the picture layer, it is possible to employ a colored ink containing, as a binder thereof, polyvinyl resin, polyamide resin, polyester resin, polyacrylate resin, polyurethane resin, polyvinyl acetate resin, polyester urethane resin, alkyd resin, etc. and containing also, as a coloring agent thereof, an appropriate pigment or dye.

The method of forming the picture layer can be a standard printing method such as the screen printing, the offset printing, the gravure printing, flexographic printing, etc. In particular, the offset printing and the gravure printing techniques are appropriate for effecting multiple color printing or gradation representation.

Further, the picture layer can be a single metal thin film layer or a combination of a decorative printing layer and a metal thin film layer. The metal thin film layer is used for presenting metal glare as a picture layer and can be formed by the vacuum deposition, sputtering, ion plating, casting technique, etc. In this case, depending on a metal glare desired to be presented, a metal such as aluminum, nickel, gold, platinum, chrome iron, copper, tin, indium, silver, titanium, lead, zinc, or n alloy or compound thereof can be employed. In general, the film thickness of the metal film layer is set at 0.05 μm approximately.

Further, optionally, when a thin metal film layer is provided, a prior-anchor or post-anchor layer can be provided for improvement of bonding performance relative to the other layers.

As the bonding layer, a heat-sensitive or pressure-sensitive resin can be appropriately employed which is suitable for use with the flexible transparent insulating substrate 8A of the upper electrode film 8 or the flexible transparent insulating substrate 9A of the decorative sheet 9. For instance, in case the flexible transparent insulating substrate 8A, 9A is of the polycarbonate type or polyamide type, a polyacrylate resin, polystyrene resin or polyamide resin can be appropriately used. Further, in case the flexible transparent insulating substrate 8A, 9A is of the acrylate type or the polyethylene terephthalate type, vinyl chloride, vinyl acetate, acryl copolymer, etc. can be suitable employed.

The method of forming the bonding layer can be a standard printing technique such as screen printing, offset printing, gravure printing, flexographic printing, etc.

Next, with reference to FIGS. 1 through 5, there will be described the configuration of the resistive touch type protective panel 4 having the touch inputting function illustrated in the instant embodiment.

First, on one face of the flexible transparent insulating substrate 8A made of a polyethylene terephthalate film (“PET film” hereinafter) in the form of a roll with a thickness of 75 μm, an amount of hard coating material of the ultraviolet-curing type acrylate resin is applied with using a roller coater, then, on this hard coating face, an indium tin oxide film (“ITO film” hereinafter) is formed by the sputtering technique. Next, the resultant product is cut into a sheet having predetermined vertical and lateral dimensions and on the ITO film, an etching resist is applied in the form of a pattern by the screen printing technique and the ITO film of unnecessary portions is removed by sulfuric acid, whereby a rectangular-shaped transparent conductive film 8B is formed. After etching, the resist is removed by alkaline wash and along the two opposing sides and the perimeter of the transparent conductive film 8B, a pair of parallel upper bus bars 8C, a pair of leader circuits 8D and a pair of connecting electrodes 8E are formed by the screen printing technique with using silver paste. Whereby, an upper electrode film 8 is obtained.

Next, on both faces of a flexible transparent insulating substrate 9A made of a PET film with thickness of 125 μm in the form of a roll, an amount of hard coating material of the ultraviolet-curing acryl type resin is applied by a roll coater and this is cut into a sheet having same lateral and vertical lengths as those of the upper electrode film 8. On one face of this sheet, a picture layer and a bonding layer formed of an transparent adhesive agent containing acrylic acid ester as the major component thereof are formed by the gravure printing technique, whereby a decorative sheet 9 is obtained.

Then, the upper electrode film 8 and the decorative sheet 9 obtained as above are affixed and bonded to each other via the bonding layer of the decorative sheet 9 in such a manner that the non-ITO film formed face of the upper electrode film 8 and the picture layer face of the decorative sheet 9 are placed in opposition to each other.

On the other hand, on both faces of a transparent insulating substrate 7A formed of a polycarbonate film (“PC film” hereinafter) with 100 μm thickness in the form of a roll, an amount of hard coating material of the ultraviolet-curing acryl type resin is applied by a roll coater, thereby to obtain a PC film having both faces thereof hard-coated. Then, on one thereof, an ITO film is formed by the sputtering technique. And, this is cut into a sheet having same lateral and vertical lengths as those of the upper electrode film 8. On the ITO film, etching resist is formed in the form of a pattern by the screen printing technique. And, the ITO film of unnecessary portions is removed by sulfuric acid, whereby a rectangular-shaped transparent conductive film 7B is formed. Next, on the entire surface of this transparent conductive film 7B, a plurality of small dot-like spacers 10 are formed by the screen printing technique with in epoxy acrylate heat-curing type resin. Also, along the opposed two sides and the perimeter of the transparent conductive film 7B, by the screen printing technique with using silver paste, a pair of parallel lower bus bars 7C, a pair of leader circuits 7D and a pair of connecting electrodes 7E are formed. Thereafter, to the pair of connecting electrodes 7E and two connecting portions 7G corresponding to the respective connecting electrodes 8E of the upper electrode film 8, an amount of adhesive agent containing nickel-plated resin beads dispersed therein is applied by the screen printing technique. Further, to the peripheral edge excluding the above portions, an amount of adhesive ink containing acrylic acid ester as the main component thereof is applied by the screen printing technique, whereby a rectangular-shaped bonding layer 7F is formed. With this, there is obtained a lower electrode film 7.

Next, to the non-ITO film formed face of the lower electrode film 7 and over its entire area thereof, a polycarbonate plate having a thickness of 1.0 mm is affixed and bonded as a supporting plate 6, with an adhesive agent containing acrylic acid ester as the main component thereof. Thereafter, of its peripheral edge portions thereof, along one lateral peripheral edge portion, four through holes 11 are formed linearly along this one lateral edge by drilling. These four through holes 11 have a diameter of 1 mm and are formed parallel with the thickness direction of the supporting plate 6 and the lower electrode film 7 and these holes extend through the connecting electrodes 7E or the connecting portions 7G. The inside of each through hole 11 is charged with an amount of silver paste as a conductive agent by using a dispenser.

Thereafter, the lower electrode film 7 affixed with the supporting plate 6 and the upper electrode film 8 affixed with the decorative sheet 9 are bonded and affixed to each other via the bonding layer 7F of the lower electrode film 7 in such a manner that the respective transparent conductive layers 7B, 8B thereof are placed in opposition to each other via air layer therebetween and the lower bus bars 7C and the upper bus bars 8C extend perpendicularly to each other and the portions of the upper electrode film 8 where the connecting electrodes 8E are formed and the corresponding portions where the through holes 11 are formed are in registry in position with each other.

Next, a flexible printed circuit (“FPC” hereinafter) comprised of a copper-foil circuit formed on one face of a polyimide film is prepared. Then, holes are formed at terminal electrode portions of this FPC. Then, these holes and the through holes 11 of the supporting plate 6 are brought into registry with each other and metal pins are inserted by an ultrasonic pressure inserting device, thus forming cables capable of taking out touch input signals on the non-lower electrode film affixed face of the supporting plate 6.

Upon completion of the above, there is obtained a resistor-film type protective panel 4 having the touch inputting function.

Inside the casing 2, there is provided an unillustrated controlling section for detecting a pressing operation to the protective panel 4 by receiving a signal from an unillustrated pressure-sensitive member. Upon detection of a pressing operation on the protective panel 4, the controlling section applies a predetermined driving voltage to a piezoelectric element 22 as an example of “oscillating element”, thereby to cause this piezoelectric element 22 to expand/contract. In this way, the protective panel 4 is configured to be oscillated in response to expansion/contraction of this piezoelectric element 22.

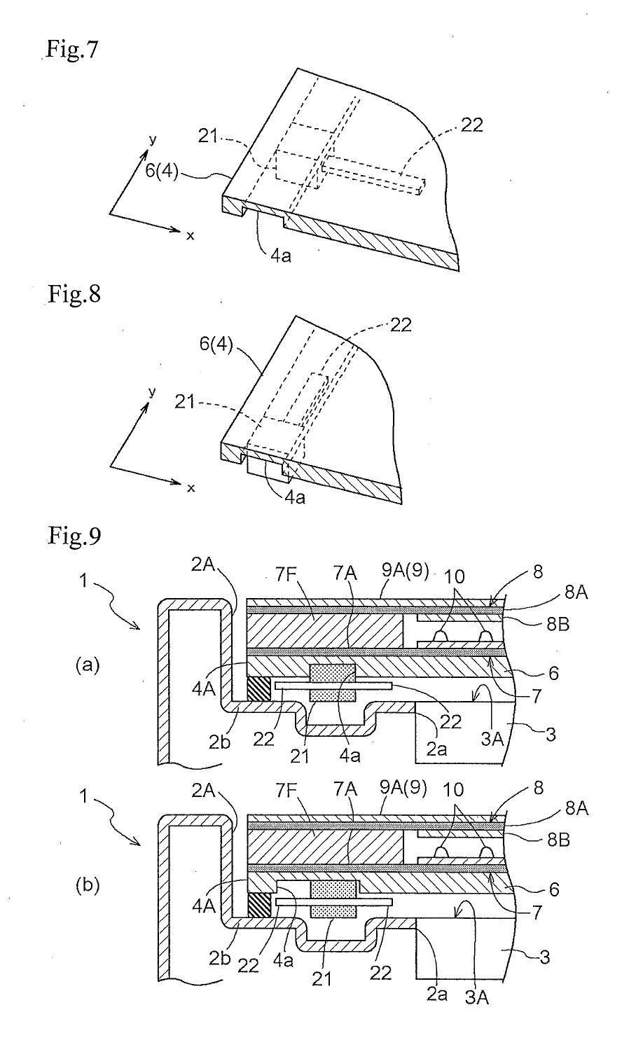

FIG. 7 is a perspective view showing a mounting arrangement of the panel member and the oscillating element in the first embodiment. Next, with reference to FIG. 2, FIG. 3, FIG. 6 and FIG. 7, the mounting arrangement of the oscillating elements 21, 22 to the protective panel 4 according to the instant embodiment will be described.

As shown in FIG. 2 and FIG. 3, the oscillating element includes a base portion 21 and the piezoelectric element 22 of the oscillating member and the piezoelectric element 22 is attached first to the base portion 21 formed of resin, and then this base portion 21 is bonded to the bottom face of the protective panel 4 with a double-sided adhesive tape or adhesive agent. When the oscillating element having the base portion 21 and the piezoelectric element 22 is disposed in contact with a supporting portion 2b of the casing 2, the supporting portion 2b will restrict oscillation of the oscillating element. Therefore, in order to avoid contact therebetween, a recess or the like will be formed in the supporting portion 2b as needed.

In the above, in the back face of the protective panel 4, a pair of recessed groove portions 4a are formed parallel with the opposing two sides of the panel peripheral edge portion 4A, and within this recessed groove portion 4a, the base portion 21 is bonded. That is, the recessed groove portion 4a corresponds to what is defined herein as a “reduced-rigidity portion”, which facilitates flexing of the protective panel 4 at this portion. Consequently, this facilitates transmission of oscillation of the piezoelectric element 22 also in the vertical (y-coordinate axis) direction of the protective panel 4.

Even when the base portion 21 of the piezoelectric element 22 is not bonded within the recessed groove portion 4a of the protective panel 4, if this base portion 21 is bonded with an offset toward the central side of the protective panel 4 from the recessed groove portion 4a of the panel 4, this arrangement too will allow oscillation of the protective panel effectively. However, the arrangement of bonding and mounting the base portion 21 of the piezoelectric element 22 within the recessed groove portion 4a provides an additional advantage of allowing reduction in the thickness of the protective panel 4 as a whole by an amount corresponding to the depth of the recessed groove portion 4a.

The reduced-rigidity portion of the protective panel 4 need not be formed along the entire peripheral edge portion 4A of the protective panel 4. For instance, it will suffice to form such portion at least at a portion of the peripheral edge portion 4A of the protective panel 4, e.g. to form it as a very small area at a corner of the protective panel or an area even smaller or shorter than the length of one side thereof. Even when the reduced-rigidity portion having reduced rigidity is formed only at a portion of the peripheral edge portion 4A of the protective panel 4, this can facilitate oscillation of the portion alone of the protective panel 4. And, by varying the position and the size of the reduced-rigidity portion of the protective panel, it becomes possible to generate various modes of oscillation depending on the intended use.

The method of forming a portion of the protective panel as a reduced-rigidity portion is not limited to formation of the recessed groove portion 4a in the protective panel 4. Alternatively, the method can be e.g. simply varying the thickness of the protective panel 4, utilizing the property of the material of the protective panel 4 without changing the thickness thereof, etc.

The shape of the piezoelectric element 22 is not particularly limited. But, like this embodiment, as shown in FIG. 7, the piezoelectric element 22 preferably is formed as an elongate oscillating element supported so-called cantilever-wise to the base portion 21. When the piezoelectric element 22 is provided with such cantilever-like shape, it is possible to increase the oscillation of the protective panel 4 while limiting the contact area between the piezoelectric element 22 and the protective panel 4 only to the small area of the base portion 21 of the piezoelectric element 22. The direction (orientation) of the piezoelectric element 22 is not particularly limited. In FIG. 7, the element 22 is caused to extend perpendicularly to the recessed groove portion 4a. Instead, the piezoelectric element 22 can be caused to extend parallel with the recessed groove portion 4a as shown in FIG. 8 or to extend obliquely relative to the recessed groove portion 4a.

### Other Embodiments

(1) In the foregoing embodiment 1, as an example of the panel member, there has been described a protective panel that covers a display device. However, the panel member relating to the present invention need not cover a display device. For instance, the inventive protective member can be used in an operational face of a flat calculator not having any display device, or in a keyboard of a computer, etc.

(2) In the foregoing embodiment 1, the reduced-rigidity portion was provided in the panel member 4 by forming a recessed groove portion 4a in the panel member 4. The measure for providing a reduced-rigidity portion at a portion of the panel member 4 is not limited thereto. Instead, a reduced-rigidity portion can be provided at a portion of the panel member 4 by varying a layer structure of the panel member 4 or varying the material thereof, etc.

(3) In the foregoing embodiment 1, the cantilever-like piezoelectric element 22 extends to only one side of the base portion 21. Instead, as shown in FIG. 9 (a), the cantilever-like piezoelectric element 22 can extend to the both sides of the base portion 21. With this arrangement, it becomes possible to control the amount of oscillation of the panel member 4. And, it becomes also possible to extend the area of the oscillation of the panel member 4 to the outer peripheral portion of the panel member outer than the position of the base portion 21.

(4) In the foregoing embodiment 1, the base portion 21 has a substantially same width as the recessed groove portion 4a of the panel member 4. Instead, the width of the recessed groove portion 4a can be made greater than the width of the base portion 21 and the piezoelectric element 21 can be disposed at a portion of this width of the recessed groove portion 4a, as shown in FIG. 9 (b).

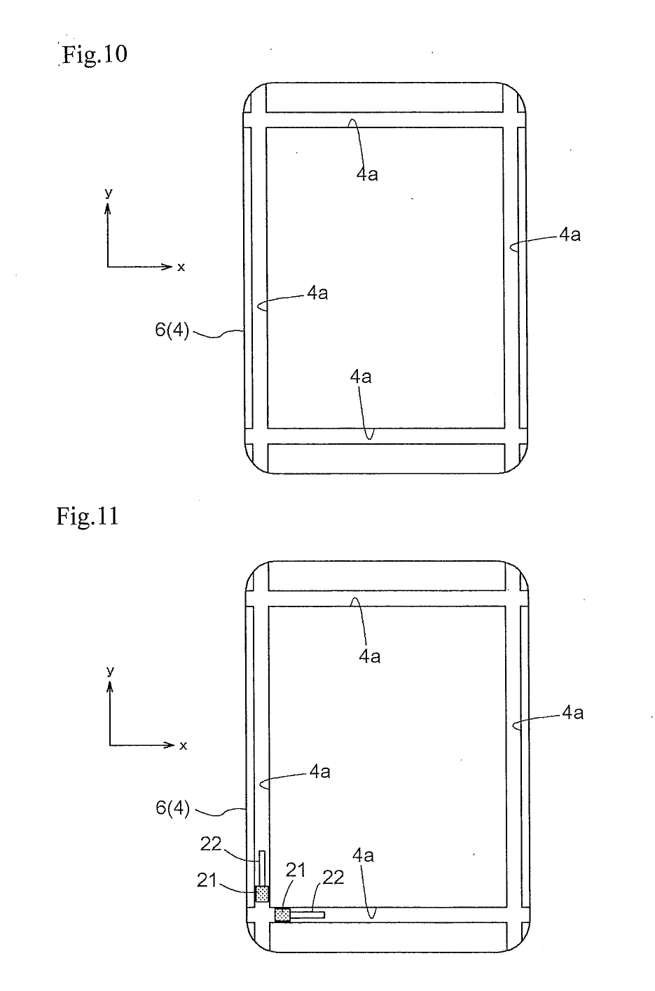

(5) Instead of forming the recessed groove portion 4a formed on the back face of the panel member 4 only along one side of the peripheral edge portion 4A of the panel member 4, it is possible to provide the recessed groove portion 4a along two or three sides thereof or along the entire perimeter thereof as shown in FIG. 10. In this case, preferably, the recessed groove portion 4a should be provided to extend to the peripheral edge of the panel member 4, in order to secure a greater area of oscillation of the panel member 4. Further, depending on the need, the recessed groove portion 4a may be provided at a plurality of portions of the panel member 4, so as to be readily capable of changing the degree of oscillation of the panel member.

(6) As shown in FIG. 11, the cantilever-like piezoelectric elements 22 can be caused to extend respectively along the vertical (y-coordinate axis) direction and the lateral (x-coordinate axis) direction from the corners of the panel member 4. With this arrangement, the oscillation of the panel member 4 can be increased, so that various modes of oscillation can be provided to the panel member 4.

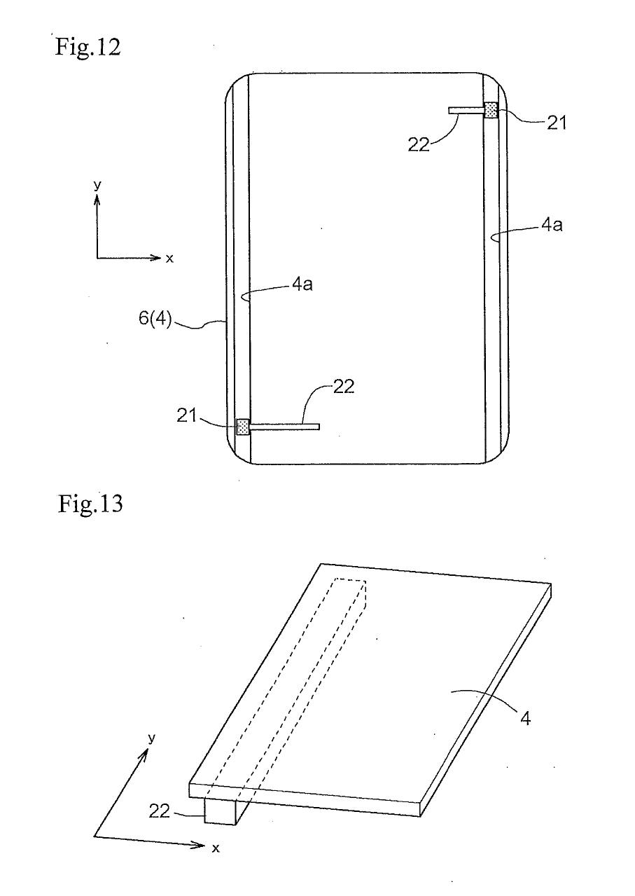

(7) As shown in FIG. 12, the cantilever-like piezoelectric elements 22 can be provided at one corner of the panel member 4 and at the other diagonally opposed corner of the same, with these piezoelectric elements having lengths made different from each other. This arrangement allows utilization of e.g. resonance effect and allows also adjustment of the width of the oscillating area and adjustment of magnitude of the oscillation of the panel member 4.

### INDUSTRIAL APPLICABILITY

The panel member according to the present invention can be effectively used in an electronic instrument, such as a mobile phone, a smart phone, a PDA, a car navigation apparatus, a digital camera, a digital video camera, a game machine, a tablet, an electronic calculator, a keyboard, etc and can be taken advantage of for improvement of performance, enhanced compactness and lightweight of the electronic instrument having the panel member.

### DESCRIPTION OF REFERENCE MARKS

1 mobile phone
2 casing
2A display window
2b supporting portion
3 display device
3A displaying section
4 protective panel (panel member)
4A peripheral edge portion
4a recessed groove portion (reduced-rigidity portion)
21 substrate or base portion
22 piezoelectric element (oscillating element)

1. A panel member having the touch type information inputting function, comprising
a reduced-rigidity portion whose rigidity is reduced is provided in at least a portion of a peripheral edge of said panel member, and
an oscillating element disposed at the center side of said panel member including the reduced-rigidity portion.

2. The panel member according to claim 1, wherein said reduced-rigidity portion is a recessed groove portion.

3. The panel member according to claim 2, wherein said panel member as a whole has a rectangular shape, and said recessed groove portion is provided at least along one side of said panel member.

4. The panel member according to any one of claims 1-3, wherein said oscillating element includes a base portion and an elongate oscillating member supported cantilever-wise from said base portion.
